(19) United States
(12) Patent Application Publication
(10) Pub. No.: US 2024/0240734 A1
(43) Pub. Date: Jul. 18, 2024

(54) DEVICE FOR PROTECTING AN INNER PART OF A PIPELINE WELD SEAM

(71) Applicant: "ES System" GmbH, Hamburg (DE)

(72) Inventor: Sergei Viktorovich NOVIKOV, Samara (RU)

(21) Appl. No.: 18/098,240

(22) Filed: Jan. 18, 2023

(51) Int. Cl. F16L 13/02

(52) U.S. Cl. CPC F16L 13/0263

(57) ABSTRACT

The invention relates to the field of pipeline construction, and in particular to means of protecting an internal weld of pipelines with an internal anti-corrosion coating. The technical result of the invention is an increase in the durability of the device during its operation. The device for protecting the inner part of the welded seam of the pipeline is made as a sleeve having flared ends and has a coating of polymer material applied to its entire surface. Stops and a heat-insulating material are provided on the outer surface of the sleeve in a heat affected zone during welding. Rubber collars are provided at a distance of L1=L(0.15÷0.2) from the ends of the sleeve, where L is the length of the sleeve. The rubber collars are configured to form a sealing bead.

### FIELD OF THE INVENTION

The invention relates to the field of pipeline construction, and in particular to means for protecting an internal weld seam of pipelines with an internal anticorrosion coating.

### BACKGROUND OF THE INVENTION

U.S. Pat. No. 5,346,261 A (13 Sep. 1994) discloses a device for protecting an inner part of a pipeline weld seam, which is made as a sleeve having flared ends. The sleeve has an anticorrosion coating, and there are stops and a heat-insulating material arranged on the outer surface of the sleeve in a heat affected zone during welding. At the opposite ends of the sleeve, there are sealing rings arranged in grooves, which form a waterproofing barrier at both ends of the sleeve when it is inserted into a pipe.

The disadvantages of the prior art solutions, including the above-indicated device, are a short service life due to the insufficiently strong coating on the surface of the sleeve, as well as increased susceptibility to corrosion. Furthermore, a bead formed after applying special sealing agents does not fill the entire cavity between a pipeline, the sleeve, and a collar due to a large tubular annulus and is subject to premature destruction from the effects of pressure and temperature. Therefore, aggressive media transported through the pipeline penetrate to the weld seam that is not protected from corrosion, thereby reducing the effectiveness of the protection and the durability of the connection and device.

### SUMMARY OF THE INVENTION

The technical problem to be solved by the invention is to eliminate the disadvantages of the prior art, expand the arsenal of technical means, increase the service life of a device for protecting an inner part of a pipeline weld seam, expand the operational characteristics and functionalities of the device. In the meantime, the installation of collars at a certain distance from the end of a sleeve provides protection throughout the service life of a pipeline with an internal anticorrosion coating.

The technical result of the invention is an increase in the durability of the device during its operation.

The technical result is achieved by that the device for protecting the inner part of the pipeline weld seam is made as a sleeve having flared ends and has a coating of polymer material applied to its entire surface. Stops and a heat-insulating material are arranged on the outer surface of the sleeve in a heat affected zone during welding. Furthermore, rubber collars are installed at a distance of L1=L(0.15÷0.2) from the ends of the sleeve, where L is the length of the sleeve. The rubber collars are configured to form a sealing bead.

Coating the surface of the sleeve with the polymer material makes it possible to preserve the device for protecting the inner part of the pipeline weld seam (hereinafter referred to as the protection device) from corrosion and, consequently, increase the durability of the device during its operation.

The flared ends of the sleeve provide a snug fit to the inner surface of the pipeline, which ensures the sealing of the tubular annulus from aggressive media transported through the pipeline, and, consequently, increases the durability of the device during its operation.

By using the stops, it is possible to rigidly fix the protection device symmetrically relative to a weld joint during installation without having to use additional devices and measuring tools, which reduces the direct contact of the protection device with the pipeline walls and increases the durability of the device during its operation.

By using the heat-insulating material, it is possible to protect the polymer coating of the protective device from thermal degradation and, consequently, to limit the development of corrosion of the base metal of the protective device, which increases the durability of the device during its operation.

By installing the rubber collars on the ends of the protection device, it is possible to provide self-centering of the protection device along the axis of the pipeline and form the sealing bead from a special sealant applied to the inner surface of the protected pipeline when the device is mounted in the pipeline, which reduces the risk of contact with an aggressive pumped medium, eliminates the development of corrosion in the zone of the weld seam, and increases the durability of the device during its operation.

By installing the rubber collars at the distance of L1=L(0.15=0.2) from the ends of the sleeve, it is possible to increase the durability of the device during its operation. This is because when installed at a distance of less than 0.15 L, the rubber collar will form a sealing bead insufficient for reliable protection against the penetration of transporting liquids that cause the corrosion of the weld seam into the tubular annulus; when installed at a distance of more than 0.2 L, the rubber collar will not reach a sealant application zone and will not form a sealing bead that completely fills the space between the device and the pipeline.

More specifically, epoxy powder paints “ [symbol] - [symbol] -585”, “ [symbol] - [symbol] -585T”, “Primatek Innopipe 67” and primers “Masscopoxy 0245”, “Primatek InnoPipe Epoxy Primer” may be used as the polymer material for the multilayer coating, which additionally increases the anticorrosion protection of the weld seam as a whole and the durability of the device during its operation.

More specifically, silica fabric and a ceramic tape which have a significantly higher heat resistance is used as the heat-insulating material, thereby additionally increasing the durability of the device during its operation.

Furthermore, a specially designed profile made of oil and petrol resistant rubber is used as the rubber collars, which makes it possible to effectively center the device along the axis of the pipelines, thereby additionally increasing the durability of the device during its operation.

### BRIEF DESCRIPTION OF THE DRAWINGS

The invention is further explained with reference to the drawings, in which:

FIG. 1 shows a front sectional view of a device for protecting an inner part of a pipeline weld seam; and

FIG. 2 shows a side sectional view of the device for protecting the inner part of the pipeline weld seam.

### DETAILED DESCRIPTION OF THE INVENTION

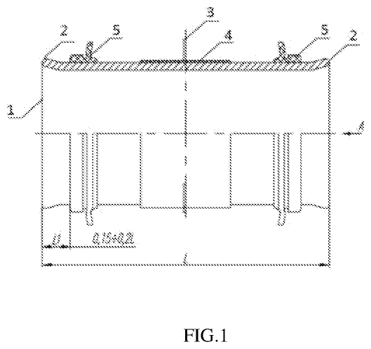

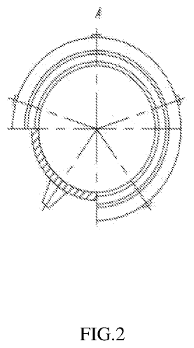

According to the FIG. 1 and FIG. 2, the protection device is made as a sleeve 1 having flared ends 2 for a snug fit to the inner surface of a pipeline. A multilayer coating of polymer material is applied to the entire outer surface of the sleeve 1. The multilayer coating may be represented by powder epoxy paints “ [symbol] - [symbol] -585”, “ [symbol] - [symbol] -585T”, “Primatek Innopipe 67” and primers “Masscopoxy 0245”, “Primatek InnoPipe Epoxy Primer”, which, when applied alternately, ensure 100% adhesion of the coating to metal: the polymer fills pores on the device, resulting in a uniform sealing layer, thereby increasing the protection of the device from external influences and also eliminating the destruction of the pipeline throughout the entire service life. Stops 3 are arranged along the transverse axis of symmetry of the sleeve 1 in a heat affected zone during welding. The presence of the stops 3 allows the protection device to take a symmetrical position relative to a weld seam during installation, which makes it possible to effectively block, on both sides of the protection device, the access of transporting fluids to the zone of the weld seam that is most susceptible to corrosion. The stops 3 may be made of steel and trapezoidal in shape, which makes it easier to cut off the tops of the stops 3 during installation after tacking pipes to each other.

In the center of the protection device, the surface of the sleeve 1 is covered with a heat-insulating material 4, which makes it possible to protect the multilayer coating of the protection device from thermal degradation and prevents the development of corrosion of the base metal of the protection device. Silica fabric or a ceramic tape may be used as the heat-insulating material 4, which additionally allows avoiding thermal destruction of the device and increasing the durability of the device during its operation. This is because these materials have a significantly higher heat resistance (up to 1000-1100° C.) compared to analogues (such as basalt fabric or fiberglass which have a heat resistance of 600° C.). Moreover, by using this material, it is possible to reduce the gap between the sleeve 1 and the pipeline to 3-4 mm (6-8 mm for analogues), thereby significantly reducing the likelihood of penetration of aggressive pumped media into the zone of the weld seam and increasing the reliability of anticorrosion protection. The need for the analogues to use the air gap of 6-8 mm is caused by the possibility of forming a reverse weld bead up to 5 mm inclusive during pipe welding according to SNIP (Construction Standards and Regulations) VSN 012-88, which can cause the overheating and thermal destruction of the anticorrosion polymer coating of the protection device.

Collars 5, which are made of rubber and may easily be folded during installation, are provided on the outer surface of the sleeve 1 from two opposite sides, symmetrically relative to the transverse axis. The rubber collars 5 lead to the formation of gaps between the protection device and the pipeline. Thus, the absence of direct contact of the protection device with the pipeline walls eliminates the risk of the thermal destruction of the coating of the protection device, which in turn eliminates the development of corrosion processes and increases the durability of the protection device. Also, as the rubber collars 5, one can use a profile made of oil and petrol resistant rubber that is more resistant to oil products.

By installing the rubber collars 5 at a distance of L1=L(0.15÷0.2) from the ends 2 of the sleeve 1 (where L is the length of the sleeve, L1 is the length of the zone from the end of the sleeve to the rubber collar 5), it is possible to increase the durability of the device during its operation. When installing the rubber collars 5 at a distance of less than 0.15 L from the end 2 of the sleeve 1, the length of the sealing bead, which is the main obstacle to the aggressive liquid, will be too small compared to the tubular annulus, and the rubber collars 5 will displace the sealant beyond the ends 2 of the sleeve 1 without forming the bead in the cavity between the pipeline, the sleeve 1 and the rubber collars 5; as a result, there will be a breakthrough of aggressive liquids to the zone of the weld seam. To provide reliable protection, the bead needs to have a length of at least 5 gaps between the sleeve 1 and the pipeline. According to the invention, the average length of the bead may be 25 mm, and based on possible annuluses of 3-4 mm, 15-20 mm is sufficient.

When installing the rubber collars 5 at a distance of more than 0.2 L from the end 2 of the sleeve 1, the sealing bead cannot be fully formed, and the rubber collars 5 will barely reach the sealant application zone on the pipes when the sleeve 1 is centered relative to the weld seam. Thus, rubber collars 5 will not collect enough sealant to fill the tubular annulus. If the sealant application zone on the pipelines is moved closer to the pipe ends, then the sealant will start to burn during welding, which is unsafe, and the combustion products of the sealant must not enter the weld. Thus, the installation range of the rubber collars 5 has a significant impact on the anticorrosion protection of the zone of the weld seam (contact with pumped media).

The collar made of the rubber profile 5 is used to form the sealing bead of epoxy mastic during the installation of the sleeve. Epoxy mastic is prepared by mixing a base and a hardener immediately before use. The prepared mastic is applied in accordance with the instructions for installing the sleeves on the inner surface of a pipe with a layer of 2-3 mm in the form of a strip 60 mm wide at a distance of 15 mm from the end of the pipe. The sleeve is inserted into the pipe cavity until the stops 3. When the sleeve is inserted into the pipe cavity, the specially profiled collar collects the applied mastic from the walls in front of it, which forms the sealing bead all the way from the collar petal to the end of the sleeve. As a result, the sealing bead made of epoxy mastic is defined by the sleeve, the pipe and the collar on three sides. To form the high-quality sealing bead, the collar has a petal arranged at a slight angle to the base of the collar. The arrangement of the petal at an angle facilitates the insertion of the sleeve into the pipe cavity. At the base, the collar petal is 1-2 mm thinner than the main profile, which contributes to the complete folding of the collar when inserting the sleeve into the pipe cavity and, consequently, increasing the width of the sealing bead and more reliable fixation of the sleeve in the pipe.

The steel sleeve 1 is made of carbon steel to achieve strength characteristics. Steel is protected from corrosion by special epoxy coatings, which are designed to work (to protect the surface from corrosion) in an oil product environment. Such coatings are used for anticorrosion protection of steel tanks, reservoirs and pipes.

The steel stops 3 are also made of carbon steels to center the sleeve relative to the weld seam first and then, after welding, hold the sleeve on the weld seam during the pipeline operation.

The heat insulation of the sleeve 4 serves to prevent thermal destruction of the anticorrosion coating of the sleeve during welding works. As the heat insulation, a 50 mm wide tape made of ceramic fibers having a heat resistance up to 1000° C. is used. The tape has an adhesive base, whereupon it can be easily mounted during the manufacture of sleeves and securely fixed during the storage, transportation and installation of the sleeves.

The protection device operates as follows.

The sleeve 1 with the rubber collars 5 is inserted half its length into one of the pipes to be joined. A sealing material (sealant) of a certain width is applied to the inner surface of the sleeve at a distance of 20-30 mm from the arrangement of a future weld seam. Another part of the sleeve 1 is respectively introduced into the second pipe with the sealant applied in a similar way. Next, the sleeve 1 is fixed by electric arc welding along the stops 3. During the installation of the rubber collars 5, the sealant bead is formed, which fills the cavity between the pipeline, the rubber collar 5 and the sleeve 1, and which prevents the penetration of an aggressive medium into the tubular annulus. Thus, the durability of the device during its operation is increased and the anticorrosion protection of the weld seam is provided.

The main advantages of the invention are as follows: an increase in chemical resistance to any aggressive media and increased protection against the penetration of aggressive media into the zone of the weld seam by reducing the tubular annulus. Thanks to the combination of all design solutions, the service life of the device during its operation is increased.

1. A device for protecting an inner part of a pipeline weld seam, wherein the device is made as a sleeve having flared ends and has a coating of polymer material applied to an entire surface of the sleeve, wherein stops and a heat-insulating material are provided on an outer surface of the sleeve in a heat affected zone during welding, and wherein rubber collars are installed at a distance of L1=L(0.15÷0.2) from the ends of the sleeve, where L is a length of the sleeve, the rubber collars being configured to form a sealing bead.

2. The device of claim 1, wherein epoxy powder paints “ [symbol] - [symbol] -585T”, “Primatek Innopipe 67” and primers “Masscopoxy 0245”, “Primatek InnoPipe Epoxy Primer” are used as the polymer material for the coating to provide reliable anticorrosion protection of the device.

3. The device of claim 1, wherein a basalt or ceramic tape is used as the heat-insulating material of the sleeve.

4. The device of claim 1, wherein a profile made of oil and petrol resistant rubber is used as the rubber collars.
